(19) United States
(12) Patent Application Publication
(10) Pub. No.: US 2009/0219493 A1
(43) Pub. Date: Sep. 3, 2009

(54) PROJECTION TYPE DISPLAY APPARATUS AND METHOD OF CONTROLLING THE SAME

(75) Inventors: Katsuaki Okubo, Ome-shi (JP); Hisayuki Mihara, Kodama-gun (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/273,394

(22) Filed: Nov. 18, 2008

(30) Foreign Application Priority Data
Feb. 29, 2008 (JP) 2008-050569

(51) Int. Cl. G03B 21/20; H04N 5/74

(52) U.S. Cl. 353/85; 348/759; 348/E05.139

(57) ABSTRACT

According to one embodiment, a projection type display apparatus, which modulates a laser beam generated from a laser beam generating element according to an input video signal and projects the modulated laser beam onto a screen via a projection lens so as to display a video, sets a light quantity of the laser beam based on information representing a size of the screen so that an optical power of the laser beam per unit area on the screen falls within a range conforming to predetermined safety standards and brightness on the screen can be secured at a maximum, and controls the laser beam generating element so that the laser beam of the set light quantity is generated.

### CROSS-REFERENCE TO RELATED APPLICATIONS

This application is based upon and claims the benefit of priority from Japanese Patent Application No. 2008-050569, filed Feb. 29, 2008, the entire contents of which are incorporated herein by reference.

### BACKGROUND

1. Field

One embodiment of the invention relates to a projection type display apparatus which projects a laser beam onto a screen so as to display a video and a method of controlling the apparatus.

2. Description of the Related Art

As is well known, projection type display apparatuses represented by, for example, color projectors project an optical image, in which an emitted light from a light source is modulated by a video signal, onto a screen so as to display a video. As the light source in the projection type display apparatuses, attention was paid to a lamp and LED (light emitting diode) and is currently paid to a laser element.

International safety standards relating to a light quantity of a laser beam is defined for devices using laser beam. In the projection type display apparatuses using the laser element as the light source, the light quantity of a laser beam emitted onto the screens should be limited based on the safety standards.

That is, in the safety standards, maximum permissible exposure (MPE) is defined as a safe level of a laser beam which can be permitted when the laser beam enters an eye or is emitted to a skin. The MPE value is set based on 1/10 of an exposure amount (level) in which a fault incidence becomes 50%. The MPE value is obtained by power density (W/m²) or energy density (J/m²) of the laser beam per unit area.

For this reason, when a radiation level of the laser beam is set so as to be smaller than the MPE value, a problem of safety does not arise. However, sufficient brightness of the laser beam cannot be secured on a screen only by setting the radiation level of the laser beam to a smaller value than the MPE value. For this reason, such projection type display apparatuses lack in practicality.

Jpn. Pat. Appln. KOKAI Publication No. 2005-091610 discloses a constitution of an image display apparatus. This apparatus has a first image display system which displays an image using a laser beam as a light source, and a second image display system which displays an image using a light source other than the laser beam. The same image is projected to be displayed by the first and second image display systems so that the brightness of the laser beam is reduced and the displayed image is made to be bright.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view illustrating an appearance of a laser projector according to one embodiment of the present invention;

FIG. 2 is a block constitutional diagram illustrating a signal processing system of the laser projector according to the embodiment of present invention;

FIG. 3 is a block constitutional diagram illustrating a constitution of a video projecting module in the laser projector according to the embodiment;

FIG. 4 is a diagram illustrating a relationship between a screen size of the laser projector and an optical power per unit area on the screen according to the embodiment of the present invention;

FIG. 5 is a diagram illustrating a relationship between a screen position of the laser projector and the optical power per unit area on the screen according to the embodiment of the present invention;

FIG. 6 is a diagram illustrating a safety countermeasure in the case where a person is in front of the screen of the laser projector according to the embodiment of the present invention;

FIG. 7 is a flow chart describing a main processing operation of the laser projector according to the embodiment of the present invention; and

FIG. 8 is a diagram illustrating one example of the relationship between the screen size of the laser projector and the optical power per unit area on the screen according to the embodiment of the present invention.

### DETAILED DESCRIPTION

Various embodiments according to the invention will be described hereinafter with reference to the accompanying drawings. In general, according to one embodiment of the invention, a projection type display apparatus, which modulates a laser beam generated from a laser beam generating element according to an input video signal and projects the modulated laser beam onto a screen via a projection lens so as to display a video, sets a light quantity of the laser beam based on information representing a size of the screen so that an optical power of the laser beam per unit area on the screen falls within a range conforming to predetermined safety standards and brightness on the screen can be secured at a maximum, and controls the laser beam generating element so that the laser beam of the set light quantity is generated.

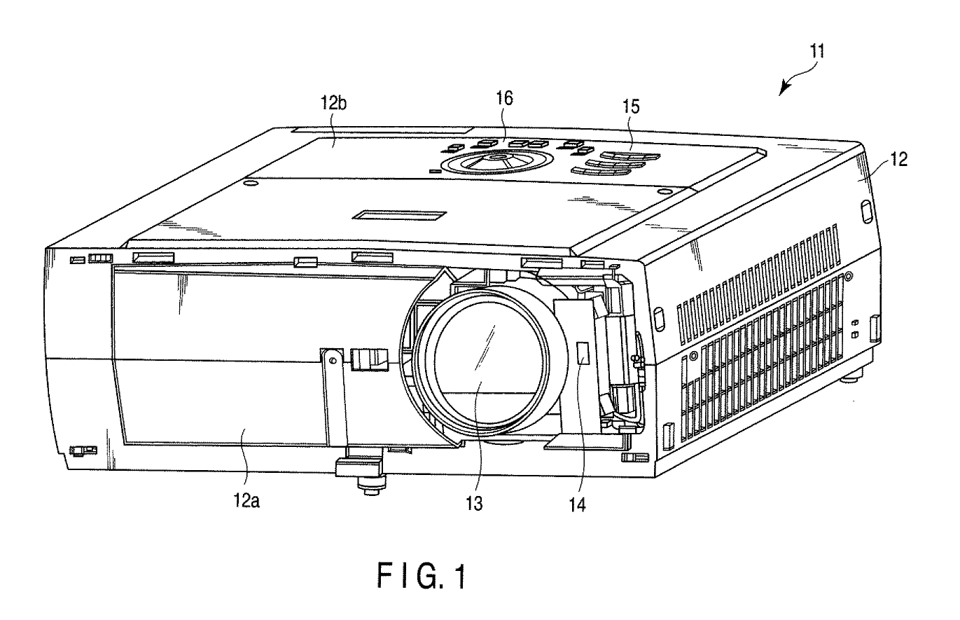

FIG. 1 illustrates an appearance of a laser projector 11 described in this embodiment. That is, the laser projector 11 has a stationary cabinet 12 which becomes a projector main body and is formed into an approximately thin box shape.

A projection lens 13 and a distance measuring module 14 are arranged proximately on one end of a front panel 12a of the cabinet 12. The projection lens 13 is for enlarging and projecting so as to display imaged information onto a screen, described later, which becomes a video projection surface provided on the front surface of the cabinet 12.

The distance measuring module 14 normally measures a distance from the projection lens 13 to the screen. When a person enters between the projection lens 13 and the screen, the distance measuring module 14 measures a distance from the projection lens 13 to the person.

A display module 15 and an operating module 16 are arranged on an upper panel 12b of the cabinet 12. The display module 15 displays a current state of the laser projector 11, or a menu for setting various modes of the laser projector 11.

The operating module 16 has a power supply key, and various keys which control various operating states or a halt state of the laser projector 11, or sets various modes of the laser projector 11. These keys are provided to be exposed from the upper panel 12b so as to be operated by a user.

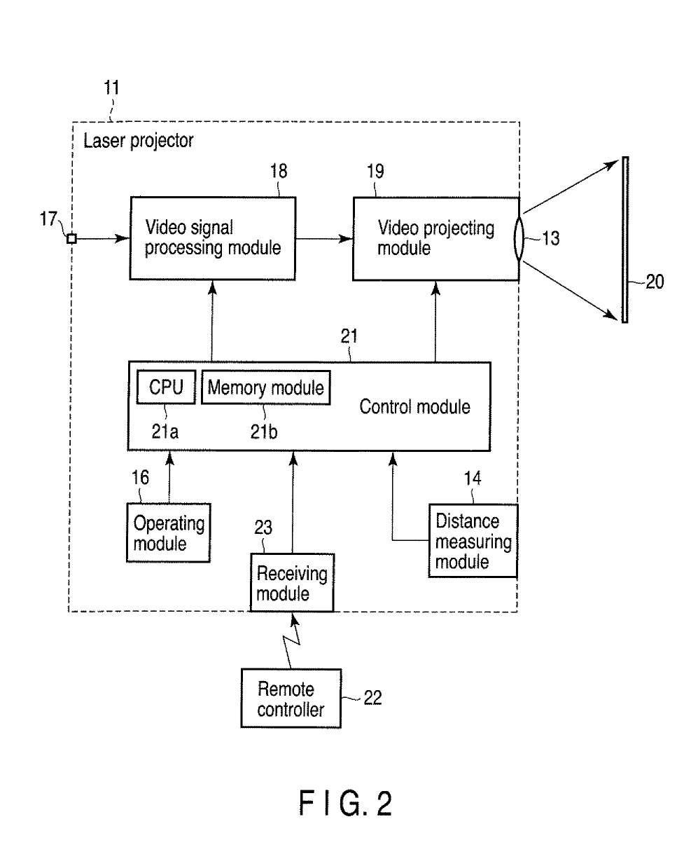

FIG. 2 illustrates a signal processing system of the laser projector 11. That is, a video signal supplied to an input terminal 17 is subject to a predetermined signal process necessary when the signal is supplied to a video signal processing module 18 so as to be projected. The video signal output from the video signal processing module 18 is supplied to a video projecting module 19 so as to be converted into an optical image. Thereafter, an optical image is enlarged and projected onto a screen 20 via the projection lens 13, and then a video is displayed.

The video display operation of the laser projector 11 is controlled by a control module 21 in an integrated manner. The control module 21 contains a CPU (central processing unit) 21a, for example, and controls the respective modules based on operating information acquired from the operating module 16 or operating information transmitted from a remote controller 22 and received by a receiving module 23 so that operating contents are reflected.

In this case, the control module 21 utilizes a memory module 21b. The memory module 21b mainly has a ROM (read only memory), a RAM (random access memory) and a nonvolatile memory. The ROM stores a control program executed by the CPU 21a therein. The RAM provides an operating area to the CPU 21a. The nonvolatile memory stores various setting information and control information therein.

The control module 21 is connected to the distance measuring module 14, and acquires distance information measured by the distance measuring module 14. When the control module 21 controls the video projecting module 19, it outputs the distance information acquired from the distance measuring module 14 to the video projecting module 19.

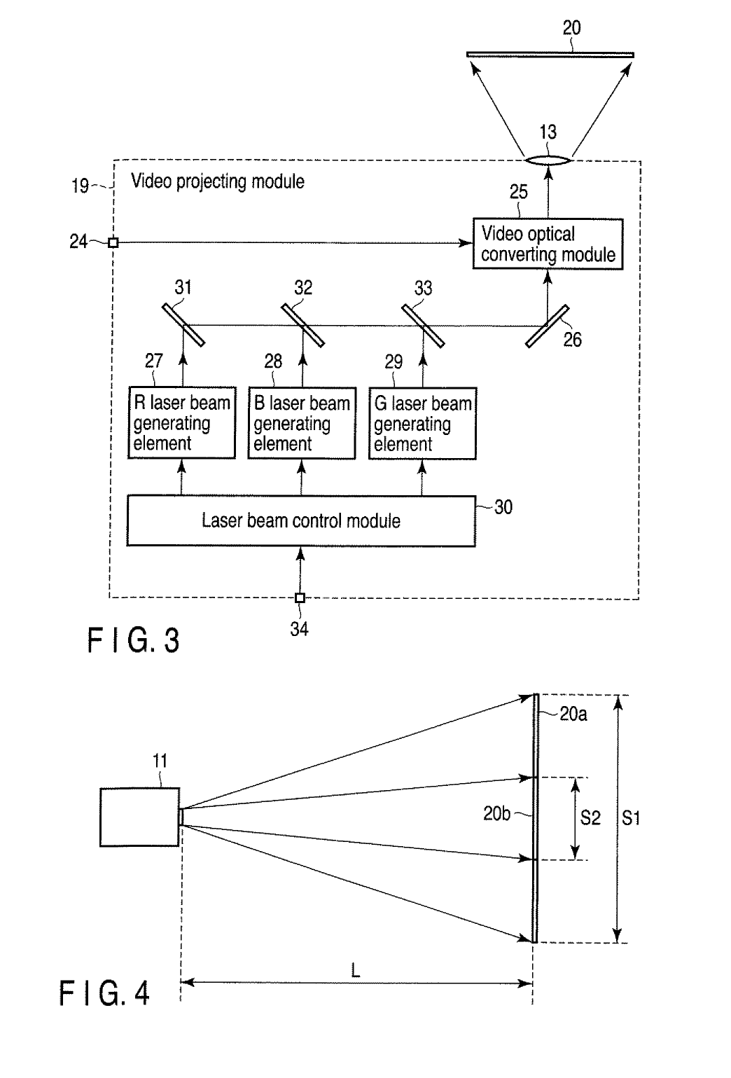

FIG. 3 illustrates a constitution of the video projecting module 19. That is, the video signal output from the video signal processing module 18 is supplied to a video optical converting module 25 via an input terminal 24. An R (red) laser beam, a B (blue) laser beam and a G (green) Laser beam are allowed to enter the video optical converting module 25 via a mirror 26 at a constant cycle in a time-division manner.

The R, B and G laser beams are generated from an R laser beam generating element 27, a B laser beam generating element 28 and a G laser beam generating element 29, respectively. The respective generating elements 27 to 29 are selectively driven based on control of a laser beam control module 30, so that the R laser beam, the B laser beam and the G laser beam are generated at a constant cycle in time-division manner. The R, B and G laser beams are allowed to enter the video optical converting module 25 via dichroic filters 31, 32 and 33, and the mirror 26.

The video optical converting module 25 modulates the R, B and G laser beams, which enter in the time-division manner, according to color component signals corresponding to the incident laser beams in the input video signal in each horizontal line. The laser beams are allowed to scan the screen 20 via the projection lens 13, so that a video is displayed.

The laser beam control module 30 controls the R, B and G laser beam generating elements 27 to 29 based on a control signal supplied from the control module 21 via an input terminal 34. In this case, the control signal supplied from the control module 21 includes the distance information measured by the distance measuring module 14 and information showing a size of the screen 20 to be used. The size of the screen 20 is expressed by a size ratio between a longitudinal direction and a lateral direction with respect to the screen 20 with a basic size.

The laser beam control module 30 sets a light quantity of laser beams based on the size of the screen 20 to be used so that an optical power of the laser beams per unit area on the screen 20 falls within a range (within MPE value) conforming to safety standards and brightness on the screen 20 is secured at a maximum. The laser beam control module 30 controls the R, B and G Laser beam generating elements 27 to 29 so that the laser beams of the set light quantity are generated.

That is, as shown in FIG. 4, a case where a screen 20a or a size S1 and a screen 20b of a smaller size S2 are provided on a position separated from the projection lens 13 by a distance L, is considered. In this case, when the light quantity of the laser beams emitted from the laser projector 11 is constant, the optical power of the laser beam per unit area on the screen 20b becomes stronger than optical power of the laser beam per unit area on the screen 20a.

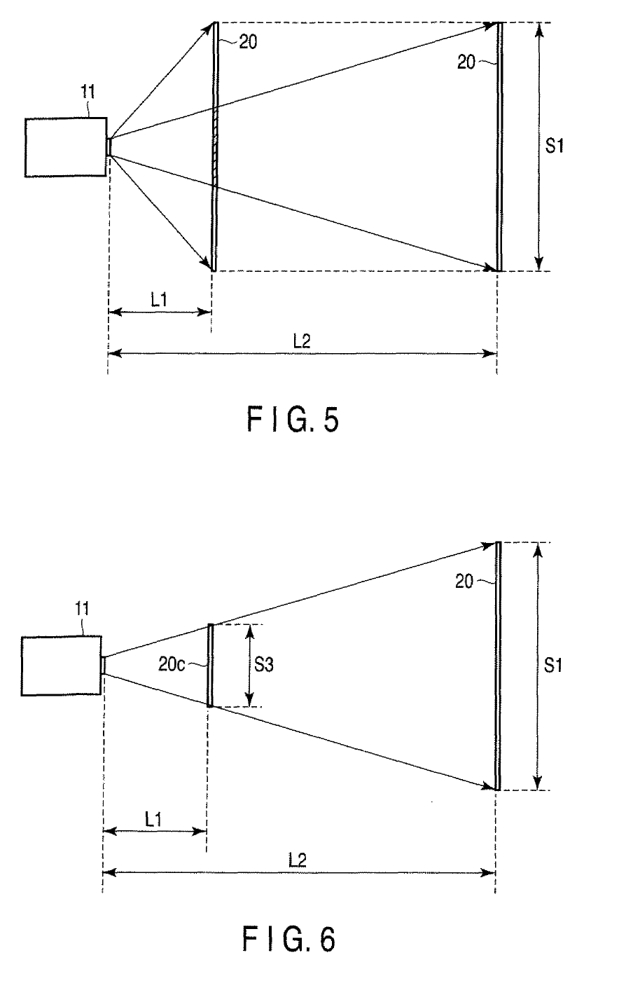

As shown in FIG. 5, however, a case where the screen 20 of the screen size S1 is installed on a position separated from the projection lens 13 by a distance L1 and a position separated by a longer distance L2, is descried. When the light quantity of the laser beam emitted from the laser projector 11 is constant, the optical powers of the laser beam on the display surfaces of the screens 20 on the positions of the distances L1 and L2 become equal to each other.

As a result, when the light quantity of the laser beam emitted from the laser projector 11 is constant, the optical power of the laser beam per unit area on the screen changes according to the size of the screen 20 regardless of the distance from the projection lens 13 to the screen 20.

For this reason, the laser beam control module 30 sets the light quantity of the laser beam based on the size of the screen 20 to be used so that the optical power of the laser beam per unit area on the screen 20 falls within the range (within MPE value) conforming to the safety standards and the brightness on the screen 20 becomes maximum. Further, the laser beam control module 30 controls the R, B and G laser beam generating elements 27 to 29.

In FIG. 5, assume that in a state that a video is projected onto the screen 20 on the position separated from the projection lens 13 by the distance L2, a person enters an emitting range of the laser beam (range shown by hatching in the drawing) between the projection lens 13 and the screen 20, such as the position separated from the projection lens 13 by the distance L1.

Since the emitting range of the laser beam is smaller than the size S1 of the screen 20, as shown in FIG. 4, the optical power of the laser beam per unit area within that range becomes stronger than the optical power of the laser beam per unit area on the screen 20. That optical power possibly exceeds the safety standards.

For this reason, when the measured result in the distance measuring module 14 is changed suddenly from the distance L2 to the distance L1, the laser beam control module 30 determines that a person enters. In this case, the laser beam control module 30 assumes that a screen 20c having a size S3 corresponding to the emitting range of the laser beam in the state that a video is projected onto the screen 20 on the position separated from the projection lens 13 by the distance L2 is provided on the position separated from the projection lens 13 by the distance L1 as shown in FIG. 6. The laser beam control module 30 sets the light quantity of the laser beam so that the optical power of the laser beam per unit area on the screen 20c falls within the range (within MPE value) conforming to the safety standards, and controls the R, B and G laser beam generating elements 27 to 29.

In this case, since a person is likely to enter there, the laser beam control module 30 has only to control the light quantity of the laser beam within the range conforming to the safety standards. It is not always necessary to control the light quantity so that the brightness on the screen 20c becomes maximum within the range conforming to the safety standards.

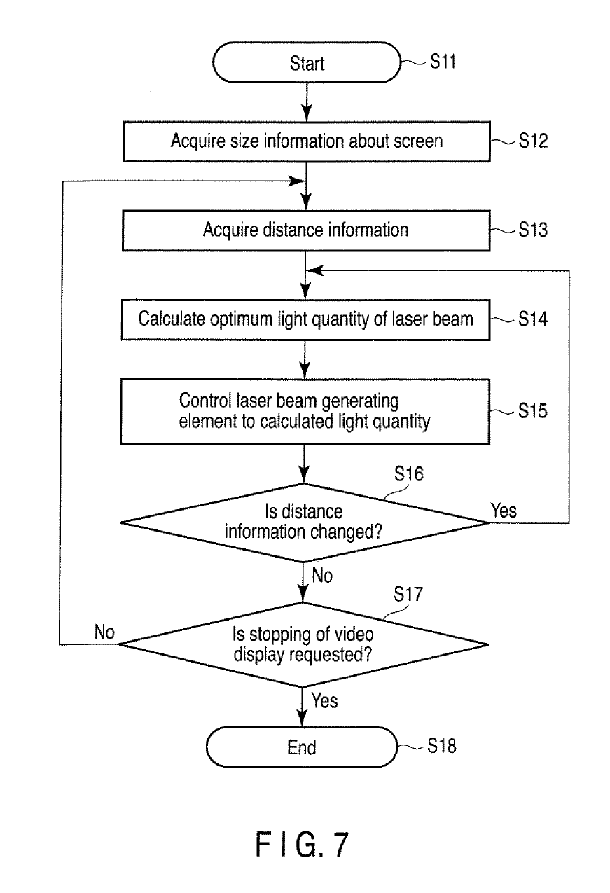

FIG. 7 illustrates a flow chart of the processing operation for controlling the light quantity of the laser beam using the laser beam control module 30. That is, this process is started by requesting video display on the screen 20 (step S11).

As a result, the laser beam control module 30 acquires size information about the screen 20 to be used at step S12. The size information about the screen 20 is defined by a video signal to be input, setting according to a user's operation, or a specification of the video optical converting module 25. The laser beam control module 30 acquires distance information measured by the distance measuring module 14 at step S13.

Thereafter, the laser beam control module 30 calculates the light quantity of the laser beam based on the acquired size information about the screen 20 at step S34 so that the optical power of the laser beam per unit area on the screen 20 falls within the range (within MPE value) confirming to the safety standards and the brightness on the screen 20 is secured at a maximum. The laser beam control module 30 controls the R, B and G laser beam generating elements 27 to 29 at step S15 so that the laser beams of the calculated light quantity are generated.

The laser beam control module 30 determines at step S16 whether the distance measured by the distance measuring module 14 changes so as to be short. When it is determined that it has changed (YES), the process goes to step 314. In this case, the laser beam control module 30 determines that the person has entered the current emitting range of the laser beams on the changed distance position. The laser beam control module 30 assumes a screen with size according to the current emitting range of the laser beams on the changed distance position, and calculates the light quantity of the laser beam so that the optical power per unit area on the assumed screen falls within the range (within MPE value) confirming to the safety standards at step S14.

When the determination is made that the distance does not change at step S16 (NO), the laser beam control module 30 determines whether stopping of video display on the screen 20 is requested at step S17. When the determination is made that the stopping is not requested (NO), the process goes to step S13 so that the distance information is acquired from the distance measuring module 14. When the determination is made that the stopping is requested (YES), the process is ended (step S18).

According to the above embodiment, the light quantity of the laser beam is set according to the size of the screen 20 to be used so that the optical power of the laser beam on the screen 20 per unit area falls within the range (within MPE value) conforming to the safety standards and the brightness of the screen 20 becomes maximum. For this reason, user's convenience is improved, and thus the embodiment is suitable sufficiently for actual use.

The distance between the projection lens 13 and the screen 20 is measured, and when the distance changes abruptly, the determination is made that a person has entered. The light quantity of the laser beam is set so that the optical power per unit area on the assumed screen with size conforming to the current emitting range of the laser beam falls within the range (within MPE value) conforming to the safety standards on the changed distance position. For this reason, sufficient safety can be secured.

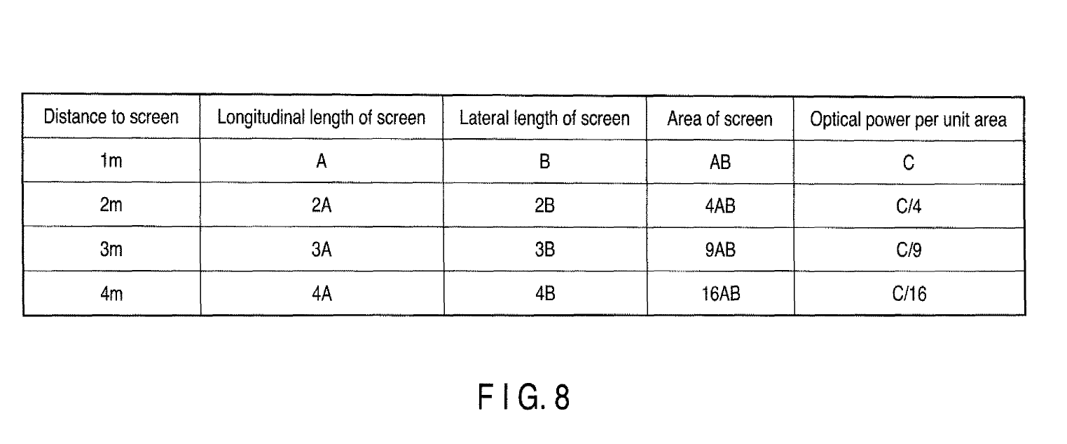

FIG. 8 illustrates one example of a relationship among the distance to the screen 20, the longitudinal length of the screen 20, the lateral length of the screen 20, the area of the screen 20 and the optical power per unit area.

That is, the case where the light quantity of the laser beam emitted from the laser projector 11 is constant is assumed. The optical power of the laser beam per unit area, at which the brightness on the screen 20 becomes maximum with longitudinal length of A and lateral length of B within the range (within MPE value) conforming to the safety standards, is C. When the longitudinal and lateral lengths of the screen 20 are doubled, the optical power is reduced to ¼, and when the longitudinal and lateral lengths of the screen 20 are tripled, the optical power is reduced to 1/9. When the longitudinal and lateral lengths of the screen 20 becomes fourfold, the optical power is reduced to 1/16.

In other words, when the longitudinal and lateral lengths of the screen 20 are doubled, the optical power per unit area on the screen 20 can be increased fourfold. When the longitudinal and lateral lengths of the screen 20 are tripled, the optical power can be increased ninefold. When the longitudinal and lateral lengths of the screen 20 are quadrupled, the optical power can be increased sixteenfold.

Before the laser beam is projected onto the screen 20, it is desirable that the light quantity of the laser beam is preset according to the size of the screen 20 to be used, and the laser beam with the set light quantity is generated. Before the laser beam is projected onto the screen 20, an infrared ray is projected and it is confirmed that no obstruction is present through the distance up to the screen 20, and the laser beam of the set light quantity is generated. As a result, safety is further ensured.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A projection type display apparatus comprising:
an input module configured to input a video signal therein;
a laser beam generating element configured to generate a laser beam;
a projecting module configured to modulate the laser beam generated from the laser beam generating element according to the video signal input into the input module and project the modulated beam onto a screen via a projection lens so as to display a video;
an acquiring module configured to acquire information representing a size of the screen; and
a control module configured to set a light quantity of the laser beam based on the information representing the size of the screen acquired by the acquiring module so that an optical power of the laser beam per unit area on the screen falls within a range conforming to predetermined safety standards and brightness on the screen can be secured at a maximum, and control the laser beam generating element so that the laser beam with the set light quantity is generated.

2. A projection type display apparatus of claim 1, wherein the control module is configured to set the light quantity of the laser beam so that the optical power of the laser beam per unit area on the screen falls within a range smaller than an MPE value and the brightness on the screen can be secured at a maximum.

3. A projection type display apparatus of claim 1, further comprising:
a distance measuring module configured to measure a distance from the projection lens to the screen,
wherein the control module is configured to acquire the distance measured by the distance measuring module when the laser beam is projected onto the screen with a predetermined size by the projecting module, assume a screen with a size conforming to an emitting range of the laser beam projected onto the screen with the predetermined size by the projecting module on a position of the measured distance when a distance shorter than the acquired distance is measured by the distance measuring module, and set the light quantity of the laser beam so that an optical power per unit area on the assumed screen falls within the range conforming to the safety standards.

4. A projection type display apparatus of claim 1, wherein
the control module is configured to, before the laser beam is generated from the laser beam generating element, set the light quantity of the laser beam in advance based on the information representing the size of the screen acquired by the acquiring module so that the optical power of the laser beam per unit area on the screen falls within the range conforming to the predetermined safety standards and the brightness on the screen can be secured at a maximum, and perform control so that the laser beam of the set light quantity is generated from the laser beam generating element.

5. A method of controlling a projection type display apparatus including an input module configured to input a video signal therein, a laser beam generating element configured to generate a laser beam, and a projecting module configured to modulate the laser beam generated from the laser beam generating element according to the video signal input into the input module and project the modulated signal onto a screen via a projection lens and display a video, the method comprising:
acquiring information representing a size of the screen; and
setting a light quantity of the laser beam based on the acquired information representing the size of the screen so that an optical power of the laser beam per unit area on the screen falls within a range conforming to predetermined safety standards and brightness on the screen can be secured at a maximum, and controlling the laser beam generating element so that the laser beam of the set light quantity is generated.

6. A method of controlling a projection type display apparatus of claim 5, wherein the controlling is for setting the light quantity of the laser beam so that the optical power of the laser beam per unit area on the screen falls within a range smaller than an MPE value and the brightness on the screen can be secured at a maximum.

7. A method of controlling a projection type display apparatus of claim 5, further comprising:
measuring a distance from the projection lens to the screen by means of a distance measuring module; and
when the laser beam is projected onto the screen with the predetermined size by the projecting module, acquiring the distance measured by the distance measuring module, and when a distance shorter than the acquired distance is measured by the distance measuring module, assuming a screen of a size according to an emitting range of the laser beam projected onto the screen with the predetermined size by the projecting module on a position of the measured distance, and setting the light quantity of the laser beam so that the optical power per unit area on the assumed screen falls within the range conforming to the safety standards, and controlling the laser beam generating element so that the laser beam of the set light quantity is generated.

8. A method of controlling a projection type display apparatus of claim 5, wherein the controlling is for, before the laser beam is generated from the laser beam generating module, setting the light quantity of the laser beam based on the acquired information representing the size of the screen so that the optical power of the laser beam per unit area on the screen falls within the range conforming to the predetermined safety standards and the brightness on the screen can be secured at a maximum, and generating the laser beam of the set light quantity from the laser beam generating module.
